(19) United States
(12) Patent Application Publication
(10) Pub. No.: US 2017/0265448 A1
(43) Pub. Date: Sep. 21, 2017

(54) Fishing Lure Container

(71) Applicant: Liam Duffy, Elon, NC (US)

(72) Inventor: Liam Duffy, Elon, NC (US)

(21) Appl. No.: 15/075,496

(22) Filed: Mar. 21, 2016

(51) Int. Cl. A01K 97/06

(52) U.S. Cl. CPC A01K 97/06

(57) ABSTRACT

A fishing lure container is provided. The fishing lure container includes an insert having a first side and a second side. Further, the container includes a plurality of threaders defining a lure end that extends from the first side of the insert for engaging an eyelet of a fishing lure. The threaders additionally include a base end securedly engaged with a backstop, wherein the backstop is positioned within the insert or proximal to the second side of the insert.

### TECHNICAL FIELD

This disclosure is related to a fishing lure container, and more particularly a fishing lure container having a plurality of secured threaders for threading lures.

### BACKGROUND

Threading fishing lures onto fishing lines is notoriously difficult. The eyelet of the lure is very small and the flexible fishing line can be difficult to position. This is particularly true when the lure is a small hook or fly, which typically have smaller eyelets than most lures. Often times the lure is threaded onto the line outdoors, while fishing in open waters or on a boat. The outdoor elements compound the problem by introducing wind and water, and often other fishing gear is being handled, which makes manipulation of the lure even more difficult.

Accordingly, there is a need for an improved fishing lure container that not only provides for organizing and storing lures, but also addresses the disadvantages associated with threading the lures onto a fishing line.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to at least one embodiment, a fishing lure container is provided. The fishing lure container includes an insert having a first side and a second side; and a plurality of threaders defining a lure end that extends from the first side of the insert for engaging an eyelet of a fishing lure and a base end securedly engaged with a backstop, wherein the backstop is positioned within the insert or proximal to the second side of the insert.

According to at least one embodiment, a plurality of compartments each including an insert having a first side and a second side; and each insert engaging a threader defining: a lure end that extends at an acute angle from the first side of the insert for engaging an eyelet of a fishing lure; and a base end securedly engaged with a backstop positioned between the second side of the insert and a wall of the compartment.

According to some embodiments, the fishing lure container further includes a first container portion and a second container portion for forming a cavity therein, wherein the insert is housed within the cavity.

According to some embodiments, the second side of the insert is securedly engaged to the second container portion and the first side of the insert is facing the first container portion.

According to some embodiments, the fishing lure container further comprises a second side of a second insert securedly engaged to the first container portion, wherein a first side of the second insert is facing the second container portion.

According to some embodiments, the container portions are pivotable relative to each other.

According to some embodiments, the fishing lure container further includes an insert arm housed within the cavity, wherein the insert is securedly engaged with the insert arm for pivoting between the container portions.\

According to some embodiments, the fishing lure container further comprises a second insert, wherein a second side of a second insert is securedly engaged to the second container portion and a first side of the second insert is facing the first container portion, wherein a second side of a third insert is securedly engaged to the first container portion and a first side of the third insert is facing the second container portion.

According to some embodiments, the fishing lure container further comprises a plurality of additional threaders extending from the second side of the insert for engaging additional fishing lures.

According to some embodiments, each of the container portions includes a gasket for providing a waterproof seal when the cavity is formed.

According to some embodiments, the threaders are arranged in parallel rows on the insert.

According to some embodiments, the lure end of the threaders are figure-eight shaped and define a small loop distal from the insert and adjacent to a collapsible loop proximal to the insert.

According to some embodiments, each of the lure ends of the threaders extends from the insert at an acute angle. In at least one embodiment, the acute angle is approximately forty-five degrees.

According to some embodiments, the insert includes an attachment on the second side for attaching the insert to a bag, tackle box or other lure receptacle.

According to some embodiments, the fishing lure container further comprises fishing lures engaged with the threaders for easy attachment to a fishing line. In at least one embodiment, the fishing lures include fly fishing lures.

According to some embodiments, the lure end of the threaders define at least one collapsible loop for securing the fishing lure to the insert when engaged with the threader.

According to some embodiments, the insert is comprised of material for accepting a hook of the lures therein.

According to some embodiments, the insert includes a slit for each threader for accepting a hook of the lures therein.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, the presently disclosed invention is not limited to the specific methods and instrumentalities disclosed. In the drawings:

FIG. 1 illustrates a perspective view of a fishing lure container having an insert with threaders according to one or more embodiments disclosed herein;

FIG. 2 illustrates a perspective view of a fishing lure container having and insert arm according to one or more embodiments disclosed herein;

FIG. 3 illustrates a perspective view of a fishing lure container having an insert with an attachment according to one or more embodiments disclosed herein;

FIG. 4 illustrates a perspective view of an fishing lure container having an insert according to one or more embodiments disclosed herein;

FIGS. 5A through 5D illustrate collapsible loops according to one or more embodiments disclosed herein; and

FIGS. 6A through 6C illustrate a method of using the threaders to thread a fishing lure onto a fishing line according to one or more embodiments disclosed herein.

### DETAILED DESCRIPTION

The presently disclosed invention is described with specificity to meet statutory requirements. However, the description itself is not intended to limit the scope of this patent. Rather, the inventors have contemplated that the claimed invention might also be embodied in other ways, to include different steps or elements similar to the ones described in this document, in conjunction with other present or future technologies.

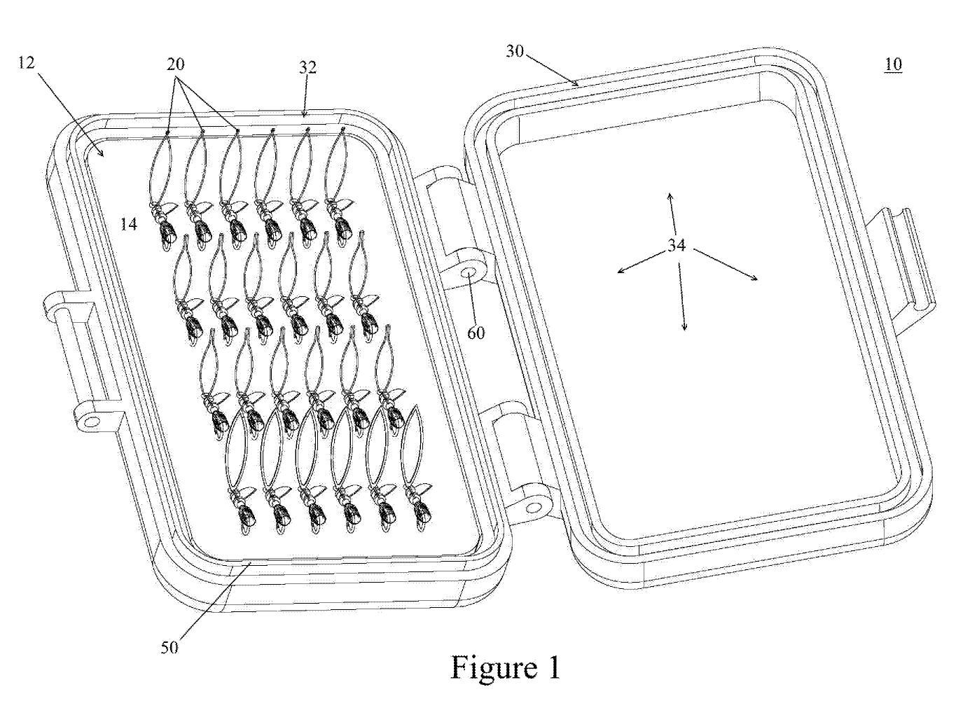

FIG. 1 illustrates at least one embodiment of a fishing lure container 10 for containing fishing lures 1 and for assisting with the passing of a fishing line 3 through the eyelet 2 of a fishing lure 1. The container 10 may include an insert 12 having a first side 14 and a second side 16. Further, the container 10 may include a plurality of threaders 20 defining a lure end 22 that extends from the first side 14 of the insert 12 for engaging an eyelet 2 of a fishing lure 1. The threader may also define a base end 24 securedly engaged with a backstop 26 positioned within the insert 12 or proximal to the second side 16 of the insert 12.

In at least one embodiment, the container 10 may include at least one fishing lure 1 engaged with the threader(s) 20 for passing of a fishing line 3 through the eyelet 2 of the lure 1. As one skilled in the art would appreciate, fishing lures 1 may include lures, hooks and flies of any number of sizes, shapes and configurations. The present invention may be particularly useful when threading a fly fishing fly or other small lure onto a fishing line.

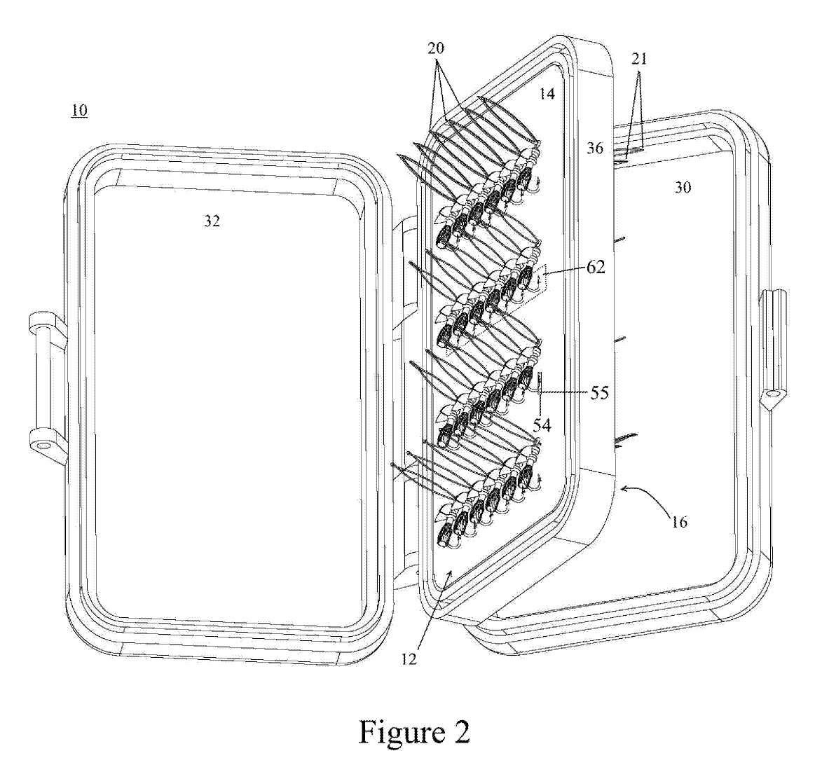

In at least one embodiment, a plurality of threaders 20 each define a lure end 22 that extends from the first side 14 of the insert 12 for engaging an eyelet 2 of a fishing lure 1. In some embodiments, a plurality of additional threaders 21 extend from the second side 16 of the insert 12 for engaging additional fishing lures 1 (e.g., see FIG. 2). The threaders 20, 21 may be arranged in parallel rows or columns on the insert 12, or any other pattern or configuration. In an alternative embodiments, users may customize the insert 12 by arranging the threaders 20 in a unique pattern themselves.

In some embodiments of the present invention, at least one lure 1 may be included with the fishing container 10, while in other embodiments lures 1 may be provided by a user of the container 10. The lures 1 may be positioned such that the eyelet 2 of the lure is between the collapsible loop 40 and one of the sides 14, 16 of the insert 12. The barb end 5 of the hook 4 of the lure 1 may be facing the side 14, 16 of the insert 12 so as to minimize the risk of injury to the user. Further, by stabilizing the orientation and position of the lures 1, the threaders 20 may keep the lures 1 from becoming entangled or disorganized. In some embodiments, the barb end 5 may engage the insert 12 for securing the lure 1 and for protecting the user from injury. For example, the barb end 5 may be inserted into the material of the insert 12 or the barb end 5 may be inserted into one or more slits 54 defined by the insert 12. In some embodiments, walls 55 of the slit 54 may secure the lure 1 by engaging sides the barb end 5, without the barb end 5 inserting into the material of the insert 12, which may cause damage to the insert 12 with repeated use. In yet another embodiment, magnets or magnetic strips 62 (see FIG. 2) may be positioned within the insert 12 for securing the barb end 5 of the lure 1. Notably, the use of magnets or magnetics strips 62 requires minimum effort to position the lures 1 and helps to reduce the wear and tear to an insert 12 made of deformable material, for example.

The lure end 22 of the threaders 20 may each extend from the insert 12 at a substantially similar angle or may each extend from the insert 12 at varying angles. The angle may be approximately forty-five degrees. The lure end 22 of the threaders 20 may define at least one collapsible loop 40 for securing the fishing lure 1 to the insert 12 when the threader 20 is passed through the eyelet 2 of the lure 1. In operation, the lure end 22 may be inserted through the eyelet 2 of the fishing lure 1, and as the lure end 22 continues to pass through the eyelet 2, the collapsible loop 40 will narrow as it collapses and passes through the eyelet 2. As the eyelet 2 continues to pass over the threader 20 towards the base end 24, the collapsible loop 40 will expand as the eyelet 2 no longer confines the loop's width.

The collapsible loop 40 of the threader 20 permits a user to more easily thread the eyelet 2 of a lure by granting the user are larger loop 40 than the eyelet 2 of the lure 1 through which to pass the fishing line 3. In addition to assistance with the threading of the lure 1 to the fishing line 3, the collapsible loop 40 may also serve, through the loop's expansion after the eyelet 2 passes thereover, to retain the lure's position, as the loop's dimensions are larger than the eyelet 2 and require directed forces to then remove the lure 2 from the threader 20. Stated another way, the expansive action of the collapsible loop 40 provides a spring-like effect on the eyelet 2, forcing the lure 1 against the insert 12 and naturally positioning the lure 1 in a particular orientation (e.g., upright) within the container 10. The consistent orientation of the lures 1 advantageously aids the display of, and therefore the ordering and selection of, the lures 1. Notably, if a lure 1 becomes dislodged from the insert 12, a slit 54 or a magnet 62, for example when an adjacent lure 1 is being threaded, the collapsible loop 40 may ensure that the lure remains affixed to the insert 12.

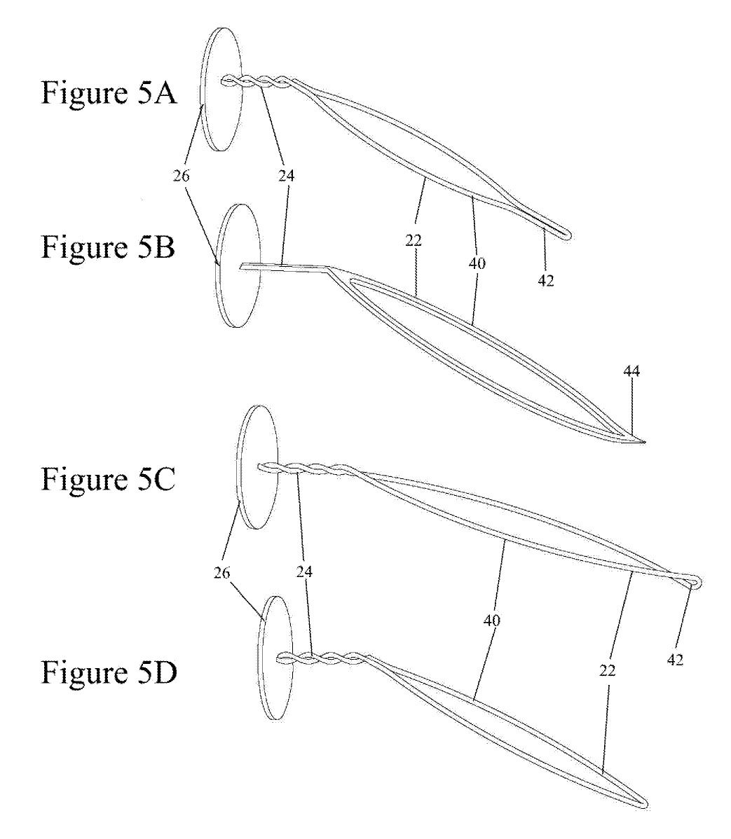

In some embodiments, the threader 20 may be figure-eight shaped and define a small loop 42 distal from the insert 12 and adjacent to a collapsible loop 40 proximal to the insert 12 (FIG. 5C). Alternatively, the threader 20 may define an extension 44 distal from the insert 12 and adjacent to a collapsible loop 40 proximal to the insert 12 (FIG. 5B). In one embodiment, the collapsible loop 40 may be coextensive with a smaller loop 42 (FIG. 5A). In any of these embodiments, the small loop 42 or extension 44 may serve to more easily thread the threader 20 within the eyelet 2 of the lure 1. The extension may be rigid or flexible, straight or arcuate, and may have a pointed end. In some embodiments, the collapsible loop 40 forms the end of the lure end 22 and does not include a smaller loop 42 (FIG. 5D).

Threaders 20 may be comprised of metal, polyurethane, elastomeric material or any other material capable of collapsing within the eyelet 2 and securing the lure 1 once passed through the eyelet 2. Further, in some embodiments, the threaders 20 may be selectively removable from the inserts 12 and/or selectively detachable from the backstops 26. In such embodiments, the threaders 20 may be replaceable. The threaders 20 may be replaceable individually, by detachment and reattachment with a backstop 26 or by selective engagement with the insert 12 itself, whether by stitching, fastening or some other engagement. In other embodiments, a row or column or other group of threaders 20 may be replaceable through disengagement and reengagement with a row or column or other group of backstops 26, or a single expansive backstop 26.

In at least one embodiment of the present invention, a backstop 26 is not included. Instead, the threaders 20 may be formed from the same continuous material, such as metal wire or plastic. In such an embodiment, the threaders 20 so conjoined may be removed and inserted through the insert 12 in unison by the user. In this manner, various types of threaders 20 may be replaced, combined and altered with various insert 12 and container 10 configurations so that the user may customize the present invention as desired.

As is depicted in FIGS. 1-3, numerous variations and configurations of the container 10 including an insert 12 with threaders 20 is envisioned. In FIG. 1, for example, the container 10 further includes a first container portion 30 and a second container portion 32 for forming a cavity 34 therein, wherein the insert 12 is housed within the cavity 34. Further, the container portions 30, 32 are pivotable relative to each other. The pivoting in FIG. 1 is effected using two cylindrical pins 60 which secure the container portions 30, 32 relative to each other, but, as one skilled in the art would appreciate, there are numerous other means by which to ensure that the container portions 30, 32 are pivotable relative to each other. Notably, the container portions 30, 32 may be pivotable relative to each other in other embodiments as well.

The container 10 depicted in FIG. 1 includes a second side 16 of the insert 12 being securedly engaged to the second container portion 32 and the first side 14 of the insert 12 facing the first container portion 30. Alternatively, the second side 16 of the insert 12 may be securedly engaged to the first container portion 30 and the first side 14 of the insert 12 may face the second container portion 32. In another embodiment, the container 10 may include a second insert 13. In such an embodiment, where the first insert 12 is securedly engaged to the second container portion 32, a second side 16 of a second insert 13 may be securedly engaged to the first container portion 30 and a first side 14 of the second insert 13 may be facing the second container portion 32.

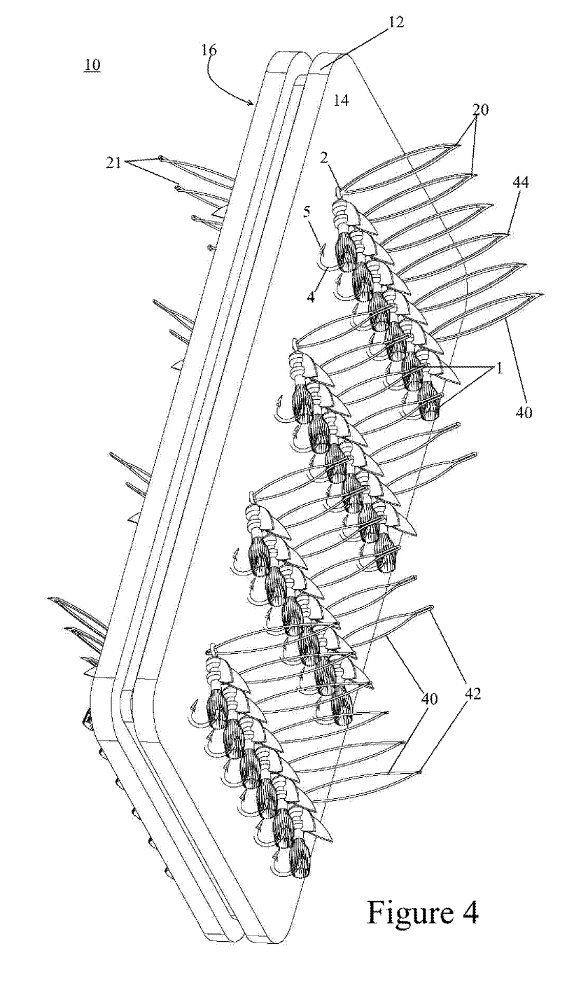

FIG. 2 depicts a container 10 further including an insert arm 36 housed within the cavity 34 of the container 10. An insert 12 may be securedly engaged with the insert arm 36 for pivoting between the container portions 30, 32. As shown, the insert 12 may include threaders 20 on a first side 14 and additional threaders 20 on a second side (see also FIG. 4). Further, although not shown in the figure, the container 10 may include at least one additional insert 13 securedly engaged to the first container portion 30 and/or second container portion 32. For example, the container 10 may further include a second side 16 of a another insert 13 securedly engaged to the second container portion 32 and a second side 16 of yet another insert 13 securedly engaged to the first container portion 30.

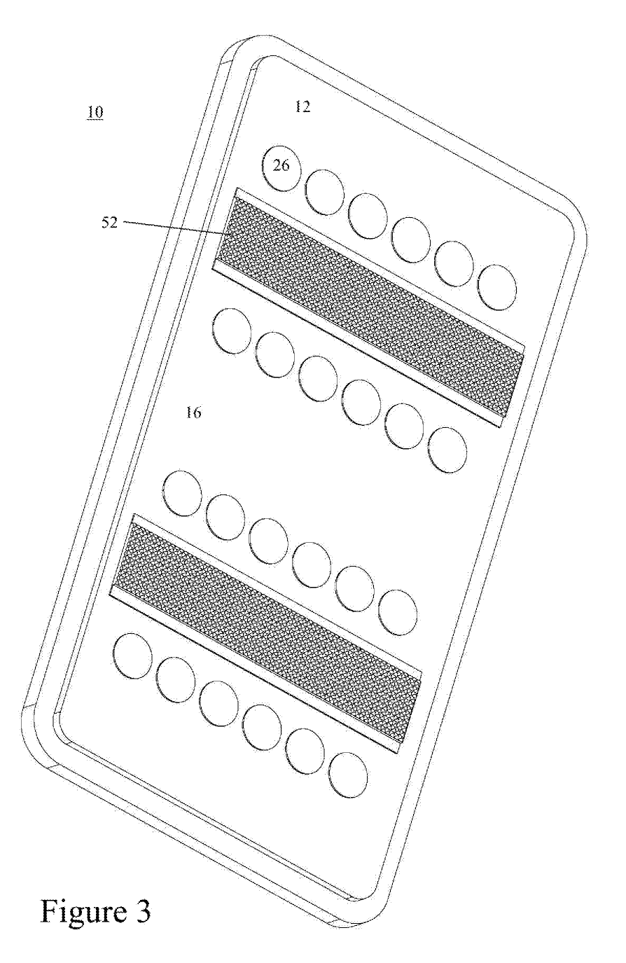

FIG. 3 depicts at least one embodiment of the container 10 including an insert 12 having an attachment 52 on either the first or second side 14, 16 for attaching the insert 12 to a bag, tackle box or other lure receptacle. Such an embodiment allows the user to place the insert 12 in any number of receptacles and/or remove the insert 12 from a receptacle so that the receptacle may be used for another purpose. Further, a container 10 including an insert 12 with an attachment 52 advantageously permits inserts 12 to be interchangeable. The attachment 52 may be a fastener, such as a hook and loop fastener or a clip or a button, or the attachment 52 may be an adhesive.

In some embodiments, each of the container portions 10 may include a gasket 50 for providing a waterproof seal when the cavity 34 is formed.

In alternative embodiments of the present invention, other objects may be threaded using the threaders 20, inserts 12 and containers 10 described herein. For example, an insert 12 with threaders 20 may be provided for threading beads for jewelry. As with the fishing lures 1, multiple beads may threaded onto a single threader 20. In some embodiments, for example, the base end 24 of the threader 20 may be equal to or longer in length than the collapsible loop 40, providing more length for which items may be positioned for easy threading. Any object having an aperture or eyelet may be threaded using the present invention. For example, even sewing needles may become more easily threaded using the present invention.

In other embodiments, a fishing lure container 10 may include a plurality of compartments each including an insert 12 having a first side 14 and a second side 16. For example, one of the container portions 30, 32 may include compartments for separate housing of a lure 1 or multiple lures 1 to prevent entanglement or to improve organization. Each compartment 56 may include its own insert 12, which in turn may have one or more threaders 20 engaged therewith. In at least one embodiment, a plurality of inserts 12 having at least one threader 20 and at least one attachment 52 may be provided. The plurality of inserts 12 may be particularly useful when retrofitting a conventional tackle box so that it may be used to assist in threading lures 1.

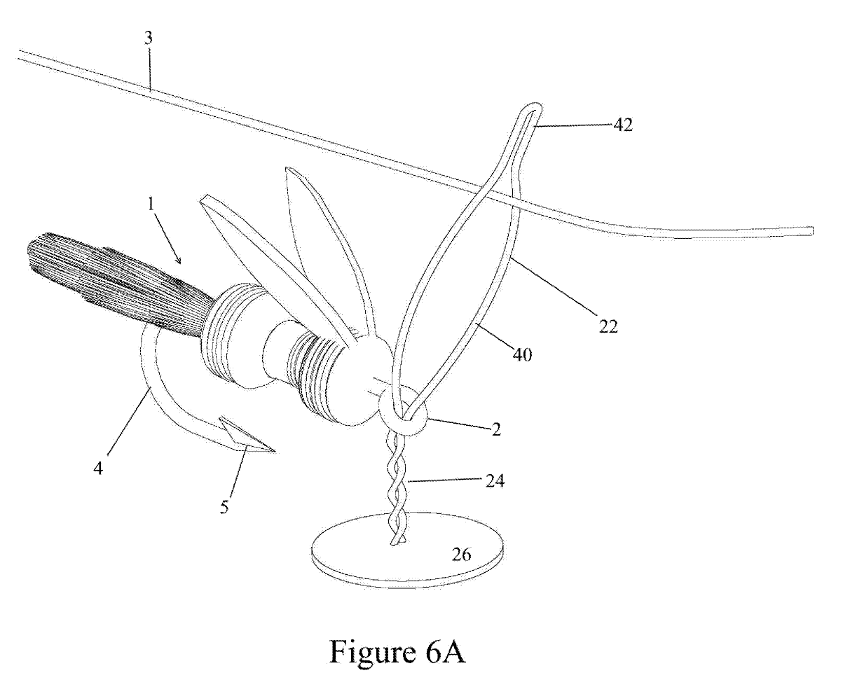

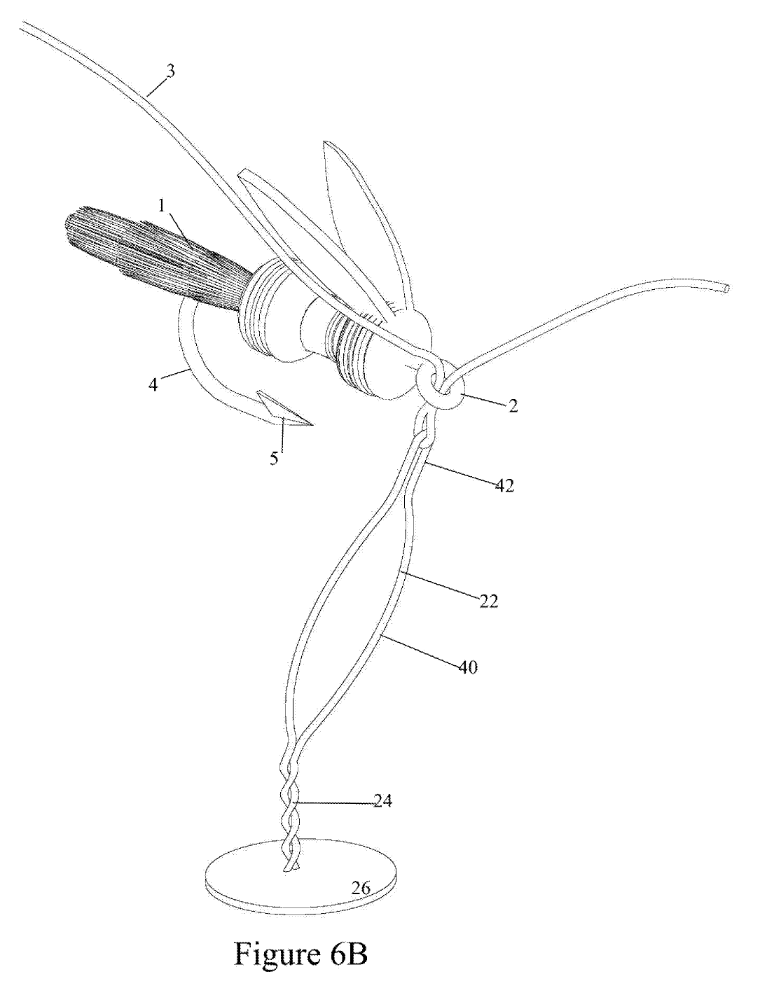

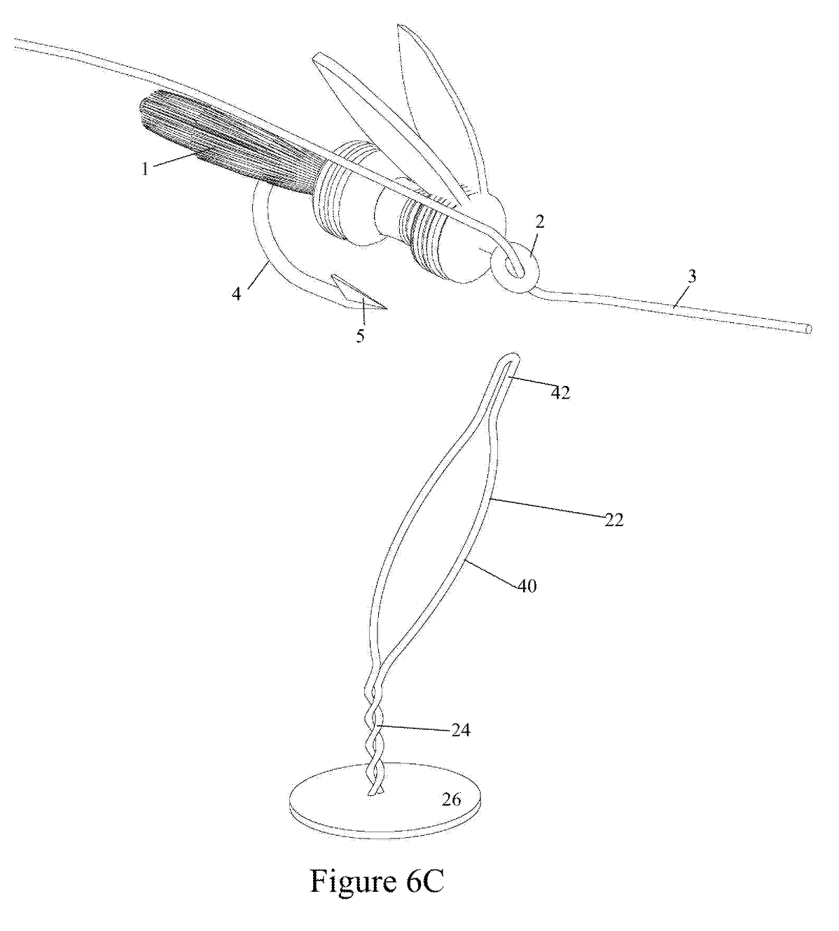

FIGS. 6-8 depict the threading of a lure 1 by a fishing line 3. In FIG. 6A, a threader 20, including the collapsible loop 40, has been inserted through the eyelet 2 of a fishing lure 1, which rests proximal to the base 24, where an insert 12 would typically be positioned. Further, one end of the fishing line 3 has been threaded through the collapsible loop 40 of the threader 20. In the second step, illustrated in FIG. 6B, the eyelet 2 of the lure 1 has been translated along the threader 20, past the lure end 22, over the collapsible loop 40 (which is shown in FIG. 6B following both initial compression and the subsequent expansion). The fishing line 3 of FIG. 6B is now threaded through the eyelet 2 of the lure 1, through the threader 20, and back through the eyelet 2 of the lure 1. As can be seen in FIG. 6C, by translating the lure 1 even further along the fishing line 3, the line 3 is now threaded through the eyelet 2 and ready for a user to secure the lure 1 to the line 3 by tying a knot. Advantageously, the process of threading the lure 1, as depicted in FIGS. 6A-6C, never involves a moment when the lure 1 is free from either the threader 20 or the fishing line 3. Additionally, the same process may be used when tying a ‘dropper’ by feeding a loop of the fishing line 3 through the threader 20, instead of threading an end of the line 3. As one skilled in the art would appreciate, threading a loop of line 3 through an eyelet 2 can be a very difficult task, but made much easier with the present invention.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

The invention claimed is:

1. A fishing lure container, comprising:
an insert having a first side and a second side; and
a plurality of threaders defining a lure end that extends from the first side of the insert for engaging an eyelet of a fishing lure and a base end securedly engaged with a backstop,
wherein the backstop is positioned within the insert or proximal to the second side of the insert.

2. The fishing lure container of claim 1, further comprising a first container portion and a second container portion for forming a cavity therein, wherein the insert is housed within the cavity.

3. The fishing lure container of claim 2, wherein the second side of the insert is securedly engaged to the second container portion and the first side of the insert is facing the first container portion.

4. The fishing lure container of claim 3, further comprising a second side of a second insert securedly engaged to the first container portion, wherein a first side of the second insert is facing the second container portion.

5. The fishing lure container of claim 2, wherein the container portions are pivotable relative to each other.

6. The fishing lure container of claim 5, further comprising an insert arm housed within the cavity, wherein the insert is securedly engaged with the insert arm for pivoting between the container portions.

7. The fishing lure container of claim 6, further comprising a second insert,
wherein a second side of a second insert is securedly engaged to the second container portion and a first side of the second insert is facing the first container portion,
wherein a second side of a third insert is securedly engaged to the first container portion and a first side of the third insert is facing the second container portion.

8. The fishing lure container of claim 6, further comprising a plurality of additional threaders extending from the second side of the insert for engaging additional fishing lures.

9. The fishing lure container of claim 2, wherein each of the container portions includes a gasket for providing a waterproof seal when the cavity is formed.

10. The fishing lure container of claim 1, wherein the threaders are arranged in parallel rows on the insert.

11. The fishing lure container of claim 1, wherein the lure end of the threaders are figure-eight shaped and define a small loop distal from the insert and adjacent to a collapsible loop proximal to the insert.

12. The fishing lure container of claim 1, wherein each of the lure ends of the threaders extends from the insert at a substantially similar angle.

13. The fishing lure container of claim 12, wherein the acute angle is approximately forty-five degrees.

14. The fishing lure container of claim 1, wherein the insert includes an attachment on the second side for attaching the insert to a bag, tackle box or other lure receptacle.

15. The fishing lure container of claim 1, further comprising at least one fishing lure engaged with at least one of the threaders for passing a fishing line through an eyelet of the fishing lure.

16. The fishing lure container of claim 15, wherein the fishing lures include at least one fly fishing fly.

17. The fishing lure container of claim 1, wherein the lure end of the threaders define at least one collapsible loop for securing the fishing lure to the insert when engaged with the threader.

18. The fishing lure container of claim 1, wherein the insert is comprised of material for accepting a hook of the lures therein.

19. The fishing lure container of claim 1, wherein the insert includes a slit for each threader for accepting a hook of the lures therein.

20. A fishing lure container, comprising:
a plurality of compartments each including an insert having a first side and a second side; and
each insert engaging a threader defining:
a lure end that extends at an acute angle from the first side of the insert for engaging an eyelet of a fishing lure; and
a base end securedly engaged with a backstop positioned between the second side of the insert and a wall of the compartment.
